(19) United States
(12) Patent Application Publication
(10) Pub. No.: US 2004/0121220 A1
(43) Pub. Date: Jun. 24, 2004

(54) Fuel cell electrode and fuel cell

(75) Inventor: Yoshihiro Ikoma, Ora-gun (JP)

Correspondence Address: McDERMOTT, WILL & EMERY, 600 13th Street, N.W., Washington, DC, 20005-3096, US

(73) Assignee: Sanyo Electric Co., Ltd.

(21) Appl. No.: 10/724,713

(22) Filed: Dec. 2, 2003

(30) Foreign Application Priority Data
Dec. 2, 2002 (JP) JP2002-349840

(51) Int. Cl. H01M 4/94; H01M 4/96

(52) U.S. Cl. 429/44; 429/42

(57) ABSTRACT

The invention provides a fuel cell and an electrode for a fuel cell, wherein a gas diffusion path and three-phase interface are secured in an air electrode, so that a desired output is stably maintained.

In a catalyst layer in the air electrode, a highly graphitized carbon particle (101) is included, in addition to a carbon particle (105) supporting a catalytic metal (107).

### BACKGROUND OF THE INVENTION

1. Field of the Invention

The present invention relates to a fuel cell electrode and to a fuel cell.

2. Description of the Related Art

Recently fuel cells have been attracting attention because they offer high energy conversion efficiency without producing a hazardous substance through power generating reaction. A polymer electrolyte fuel cell that operates in a temperature as low as below 100 degrees centigrade is known as one of such fuel cells.

A polymer electrolyte fuel cell is basically constituted of a fuel electrode and an air electrode with a solid polymer membrane disposed therebetween for serving as an electrolyte membrane, and is designed to generate electricity according to the following chemical reaction formula upon supplying hydrogen to the fuel electrode and oxygen to the air electrode.

Fuel electrode: H₂→2H⁺+2e⁻ (1)

Air electrode: 1/2O₂+2H⁺+2e⁻→H₂O (2)

The fuel electrode and the air electrode respectively consist of a catalyst layer and a gas diffusion layer laid over each other. These electrodes are placed in such a manner that the catalyst layers of the respective electrodes confront each other via the solid polymer electrolyte membrane, thus to constitute a fuel cell. The catalyst layer consists of carbon particles supporting a catalyst bound by an ion exchange resin. The gas diffusion layer serves as a path for oxygen and hydrogen. Power generating reaction takes place at so-called a three-phase interface among the catalyst in the catalyst layer, the ion exchange resin and reactant gases.

In the fuel electrode, hydrogen contained in supplied fuel gas is decomposed into a proton and an electron as shown in the formula (1). The proton moves toward the air electrode through inside the solid polymer electrolyte membrane, while the electron moves to the air electrode through an external circuit. In turn, on the side of the air electrode, oxygen contained in an oxidant gas supplied to the air electrode reacts with the proton and the electron that have come over from the fuel electrode, to give water as shown in the formula (2). Accordingly, electricity can be taken out of the external circuit where the electron moves from the fuel electrode toward the air electrode.

There used to be a drawback in such fuel cell that water produced at the air electrode as a result of the reaction pooled in the catalyst layer of the air electrode and disturbed diffusion of the gas involved in the reaction, thereby reducing output of the fuel cell. Even in case where a water-repellent material such as PTFE (polytetrafluoroethylene) was added in the catalyst layer in order to secure a diffusion path for the gas in the air electrode, cell characteristics still lowered with the lapse of time since the water-repellent material coated over a surface of the catalyst particles. Accordingly, a proposal was made to the effect of employing water-repellent carbon particles for supporting a catalyst, to secure a gas diffusion path (JPA laid open 2000-268828).

However according to JPA laid open 2000-268828, since the carbon material itself is water-repellent, a catalyst-supported carbon particle based on such carbon material is not sufficiently compatible with an ion exchange resin, therefore a contacting area between the ion exchange resin and the catalyst-supported carbon particle is limited. Consequently an area of three-phase interface was reduced, and it has been equally difficult to improve output performance of a fuel cell.

Related Art List

JPA laid open 2000-268828

The present invention has been conceived in view of the foregoing situation, with an object to provide a fuel cell and an electrode for the fuel cell wherein a gas diffusion path and a three-phase interface is secured in an air electrode, so that the fuel cell can stably provide a desired output.

### SUMMARY OF THE INVENTION

According to the present invention there is provided an electrode for a fuel cell comprising a gas diffusion layer; and a catalyst layer formed over the gas diffusion layer; wherein the catalyst layer comprises a first carbon particle, a catalytic metal supported on the first carbon particle, an ion exchange resin and a second carbon particle; and a surface of the second carbon particle is water-repellent.

In the electrode for a fuel cell according to the present invention, the catalyst layer includes a water-repellent second carbon particle. Therefore, water that has been produced through the reaction of the formula (2) is promptly discharged from a surface of the second carbon particle toward outside the catalyst layer. As a result a gas diffusion path in the catalyst layer is secured. At this stage, the second carbon particle existing in the catalyst layer is independent from the first carbon particle supporting a catalytic metal. To a surface of the first carbon particle, which is hydrophilic, the ion exchange resin adheres, therefore a three-phase interface is secured. Besides, since the carbon material is conductive, existence of the second carbon particle in addition to the first one provides increased moving path for the electron, thus improving conductivity in the catalyst layer.

Accordingly, on a surface of the first carbon particle the catalytic reaction takes place efficiently; a gas diffusion path is secured on a surface of the second carbon particle; and conductivity is improved owing to the existence of the second carbon particle in addition to the first one, therefore an excellent performance is accomplished as a fuel cell. Also, since a water-repellent surface is separately located from a catalyst surface water is retained on the catalyst surface, which upgrades safety of the electrode.

In the electrode for a fuel cell according to the present invention, an average value of lattice spacing of the [002] plane, d₀₀₂, of the second carbon particle is not less than 0.337 nm but not greater than 0.348 nm.

While a carbon particle surface is hydrophilic by nature, a highly graphitized carbon material becomes water-repellent. Though the reason is unconfirmed yet, it is considered that water-repellency emerges because of reduction of a total number of dangling bonds from a same number of carbons since graphitization increases an area of hexagonal plane causing increase in number of covalent bonds. Also, as a degree of graphitization becomes higher, the carbon material becomes more conductive.

A graphite is a crystal regularly layered carbon atom hexagonal planes, and a degree of graphitization is represented by an average separation between the hexagonal planes (hereinafter referred to as “average separation of [002] lattice planes”) d₀₀₂, or a crystallite size in a direction of c-axis, L_{c}. The graphitization degree value is approx. 0.344 in case where the hexagonal planes are not regularly layered, but the value becomes closer to 0.3354 as the layers become more regularized, i.e. as the carbon graphitization degree becomes higher.

Therefore, employing a highly graphitized carbon particle having a water-repellent surface and high conductivity as the second carbon particle in a catalyst layer for a fuel cell electrode enables simple and assured improvement of electrode characteristics.

Also, in the fuel cell electrode according to the present invention, a crystallite size in a direction of c-axis of the second carbon particle may be made not less than 3 nm but not greater than 18 nm. As a result, the second carbon particle becomes highly graphitized with a water-repellent surface.

Further, in the fuel cell electrode according to the present invention, the gas diffusion layer may also be loaded with the first carbon particle and the second carbon particle.

Since a surface of the first carbon particle is hydrophilic, loading the first carbon particle in the gas diffusion layer enables formation of a moisture moving path in the gas diffusion layer. Also, since a surface of the second carbon particle is water-repellent, a gas diffusion path is formed. Consequently, moisture produced in the catalyst layer can be more promptly discharged outside the electrode through the gas diffusion layer. Besides, loading the second carbon particle improves conductivity of the gas diffusion layer. As a result, the electrode characteristics can be further upgraded.

According to the present invention, there is provided a fuel cell comprising a fuel cell electrode on fuel supply side; a fuel cell electrode on oxygen supply side; and a solid polymer electrolyte membrane placed between the electrodes; wherein at least the fuel cell electrode on oxygen supply side is the foregoing fuel cell electrode.

In the fuel cell according to the present invention, since the aforementioned fuel cell electrode is utilized as the air electrode, catalytic reaction efficiently takes place at the air electrode and moisture resultantly produced is promptly discharged outside the cell. Therefore, it becomes possible to increase an output of the fuel cell and to maintain the output at a stable level.

### BRIEF DESCRIPTION OF THE DRAWINGS

FIG. 1 is a conceptual drawing showing a catalyst layer in an air electrode of a fuel cell according to the embodiments;

FIG. 2 is a conceptual drawing showing a gas diffusion layer in the air electrode of the fuel cell according to the embodiment;

FIG. 3 is a conceptual cross-sectional view showing the fuel cell according to the embodiment; and

FIG. 4 is a conceptual drawing showing a cross-section of a cell unit of the fuel cell of FIG. 3.

### DESCRIPTION OF THE PREFERRED EMBODIMENTS

Referring to the accompanying drawings, the embodiments of the present invention will be described hereunder.

First Embodiment

This embodiment relates to a fuel cell provided with an air electrode having a catalyst layer containing a highly graphitized carbon particle. Firstly, structure of a polymer electrolyte fuel cell according to this embodiment will be described.

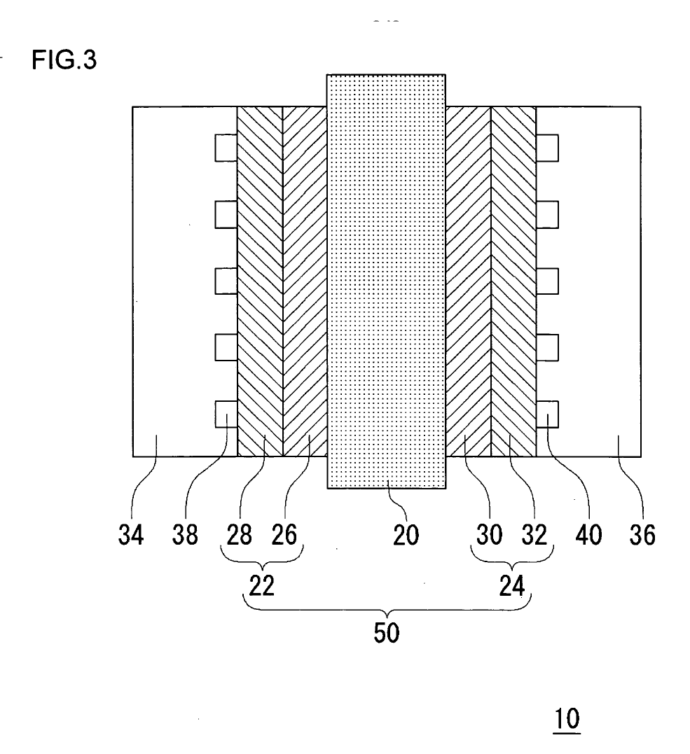

FIG. 3 is a conceptual cross-sectional view showing a fuel cell 10 according to the embodiment of the present invention. The fuel cell 10 is provided with a plate-formed cell unit 50, on both sides of which a separator 34 and another separator 36 are placed. This embodiment shows a single cell unit 50, however a plurality of cell units 50 may be layered via the separator 34 or 36 to constitute the fuel cell 10. The cell unit 50 includes a solid polymer electrolyte membrane 20, a fuel electrode 22 and an air electrode 24. The fuel electrode 22 and the air electrode 24 may be called a “catalyst electrode”. The fuel electrode 22 includes a catalyst layer 26 and a gas diffusion layer 28 layered over each other, and the air electrode also includes a catalyst layer 30 and a gas diffusion layer 32 layered over each other. The catalyst layer 26 of the fuel electrode and the catalyst layer 30 of the air electrode 24 are disposed so as to face each other via the solid polymer electrolyte membrane 20.

The separator 34 placed on the side of the fuel electrode 22 is provided with a gas path 38, through which a fuel gas is supplied to the cell unit 50. Likewise, the separator 36 placed on the side of the air electrode 24 is also provided with a gas path 40, through which oxidant gas is supplied to the cell unit 50. Specifically, during operation of the fuel cell 10 a fuel gas such as hydrogen is supplied to the fuel electrode 22 through the gas path 38, and an oxidant gas, for example air, is supplied to the air electrode 24 through the gas path 40. This situation causes electricity generating reaction in the cell unit 50. When hydrogen is supplied to the catalyst layer 26 through the gas diffusion layer 28 the hydrogen in the gas turns into proton, and the proton moves toward the air electrode 24 through the solid polymer electrolyte membrane 20. Electron emitted at this stage moves to an external circuit and flows into the air electrode through the external circuit. Meanwhile, when air is supplied to the catalyst layer 30 through the gas diffusion layer 32, the oxygen joins with the proton to become water. As a result, the electron runs from the fuel electrode 22 to the air electrode 24 through the external circuit, therefore electricity can be taken out of the external circuit.

It is preferable that the solid polymer electrolyte membrane 20 offers high ion conductivity in a wet condition, because of its function as an ion exchange membrane for moving the proton between the fuel electrode 22 and the air electrode 24. The solid polymer electrolyte membrane 20 maybe constituted of a solid polymer material such as a fluorine-based polymer or a non-fluorine polymer, including sulfonated perfluorocarbon polymer, sulfonated resin, or a perfluorocarbon polymer containing a phosphonic acid group or a carboxylic acid group, etc. As an example of the sulfonated perfluorocarbon polymer, Nafion (manufactured by E.I. du Pont de Nemours and Company, registered trademark) 112 can be cited. Also, examples of non-fluorine polymer include aromatic polyetherketone, polysulfone, etc.

The catalyst layer 26 in the fuel electrode 22 and the catalyst layer 30 in the air electrode are porous membranes, preferably constituted of an ion exchange resin and carbon particles supporting a catalyst. It is preferable to employ one or a combination of two or more among platinum, ruthenium, rhodium, etc. as the catalyst to be supported. Also, acetylene black, Ketjenbalck, carbon nanotube, etc. may be used as the carbon particle to carry the catalyst.

The ion exchange resin serves to electrochemically connect the carbon particle supporting a catalyst with the solid polymer electrolyte membrane 20, and has to have proton permeability in the fuel electrode 22, and oxygen permeability in the air electrode 24. The ion exchange resin may be formed of a similar polymer material to that of the solid polymer electrolyte membrane 20.

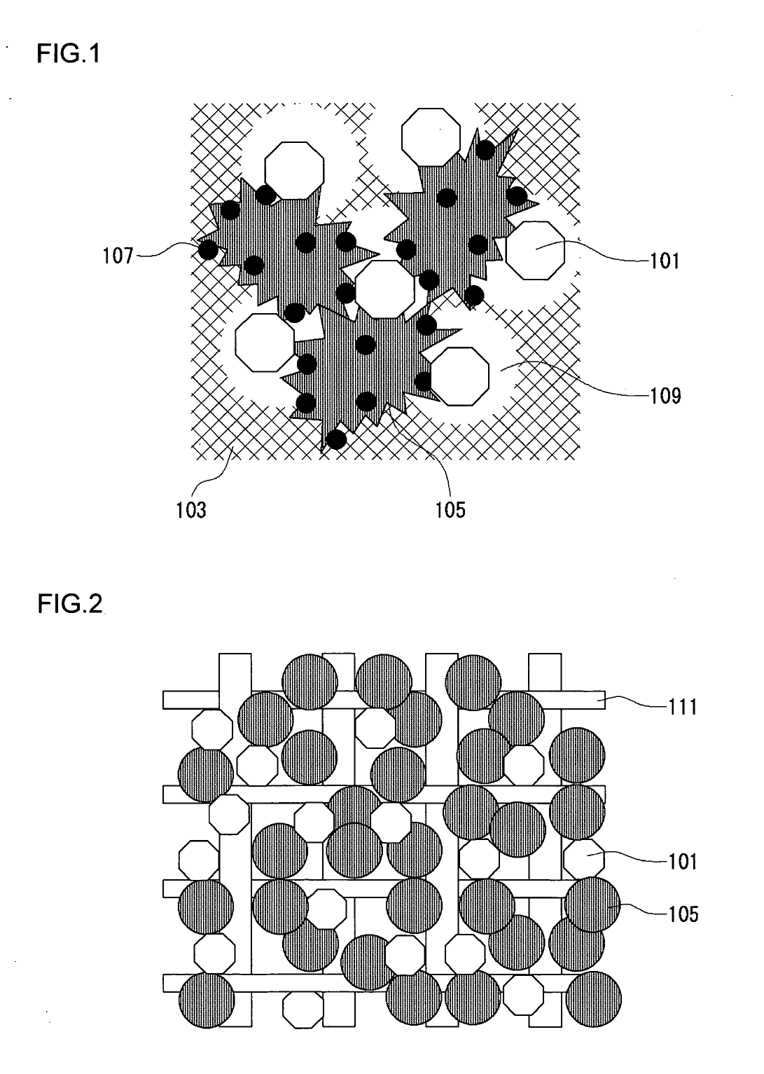

Now, the catalyst layer 30 in the air electrode 24 may further include highly graphitized carbon particles. FIG. 1 is a conceptual drawing showing the catalyst layer 30 in the air electrode 24. In FIG. 1, a carbon particle 105 carries a catalytic metal 107, around which ion exchange resin 103 is dispersed. Also, since a highly graphitized carbon particle 101 has a water-repellent surface, a gas diffusion section 109 is formed in the proximity of the surface of the highly graphitized carbon particle 101.

Accordingly, since the catalyst layer 30 includes the highly graphitized carbon particle 101, water produced in the air electrode 24 is promptly discharged through the gas diffusion section 109 on the surface of the highly graphitized carbon particle 101. Also, oxygen can be efficiently supplied through the gas diffusion section 109, because this can also be utilized as a gas diffusion path. At this stage, since the catalytic metal 107 is supported on the carbon particle 105 for supporting a catalyst, which has a hydrophilic surface, the ion exchange resin 103 is located in the proximity of the surface of the carbon particle and the catalytic metal 107. Therefore, a location of the gas diffusion section 109 is isolated from the catalytic reaction section on the surface of the carbon particle 105 for supporting catalyst. Consequently, a three-phase interface and a gas moving path are both secured in the catalyst layer 30. Besides, since the highly graphitized carbon particle 101 is included in the catalyst layer 30 in addition to the carbon particle 105 for supporting catalyst, conductivity of the catalyst layer 30 is improved.

According to the foregoing description, since the catalyst layer 30 in the air electrode 24 has excellent electrode characteristics, the fuel cell 10 stably provides a high output under upgraded safety.

For the highly graphitized carbon particle 101, it is preferable to employ a carbon particle that is graphitized to a high extent, such as one that has an average lattice spacing of the [002] plane, d₀₀₂, of not less than 0.337 nm but not greater than 0.348 nm. When d₀₀₂ is 0.337 nm or greater a specific surface area of the highly graphitized carbon particle 101 becomes sufficiently large, therefore a sufficient gas diffusion path can be secured. Also, when d₀₀₂ is 0.348 nm or less, the extent of graphitization is sufficiently high and the surface becomes water-repellent. Further, it is more preferable that d₀₀₂ is in a range of 0.342 nm to 0.346 nm.

Also, it is preferable to employ a carbon particle that has a crystallite size in a direction of c-axis, L_{c}(002), of not less than 3 nm but not greater than 18 nm. When L_{c} is 3 nm or greater, the extent of graphitization is sufficiently high and the surface becomes water-repellent. When L_{c} is 18 nm or less a specific surface area of the highly graphitized carbon particle 101 becomes sufficiently large, therefore a sufficient gas diffusion path can be secured. Further, it is more preferable that L_{c} is in a range of 3.5 nm to 8 nm.

Examples of the highly graphitized carbon particle 101 that satisfy the above quality include a high-purity artificial graphite, high-purity spherical graphite, high-purity natural graphite, high-quality carbon (all manufactured by SEC Corporation), etc.

Also, it is preferable that a content of the highly graphitized carbon particle 101 in the catalyst layer 30 is in a range of 10 wt. % to 50 wt. % with respect to a weight of the entire catalyst layer 26. With 10 wt. % or more of the highly graphitized carbon particle 101, a gas diffusion path and moisture discharging path can be surely formed. Also, with 50 wt. % or less of the same, since sufficient amounts of ion exchange resin 103 and carbon particle 105 supporting a catalytic metal 107 are contained in the catalyst layer 26, the catalytic reaction can be efficiently performed. Referring to the mixing condition in this aspect, it is preferable to adjust as, for example, (carbon particle 105+catalytic metal 107)/ion exchange resin 103/highly graphitized carbon particle 101=10/15/10. Under this proportion, excellent electrode characteristics can be achieved.

The gas diffusion layer 28 in the fuel electrode 22 and the gas diffusion layer 32 in the air electrode 24 serve to convey the supplied hydrogen gas or air to the catalyst layer 26 or the catalyst layer 30. Also, these gas diffusion layers have the functions to transfer the electric load generated by the electricity generating reaction to an external circuit and to discharge moisture or surplus gas outside. It is preferable that the gas diffusion layer 28 and the gas diffusion layer 32 are constituted of an electronically conductive porous material, such as a carbon paper or a carbon cloth.

Hereunder, a method of manufacturing the cell unit 50 will be described. Firstly, a carbon particle 105 is caused to carry a catalytic metal 107 such as platinum by impregnation or colloid method, to form the fuel electrode 22 and the air electrode 24. A compound thus obtained from the carbon particle 105 and the catalytic metal 107 is referred to as a catalyst-supported carbon particle. Then the obtained catalyst-supported carbon particle and an ion exchange resin 103 are dispersed in a solvent, so that a catalytic ink is made. Here, for the air electrode 24 the highly graphitized carbon particle 101 is also added to the catalyst-supported carbon particle and the ion exchange resin 103 when dispersing in a solvent to make a catalytic ink.

At this stage the aforementioned materials may be used as the highly graphitized carbon particle 101, otherwise it is also possible to perform graphitization of carbon particles. In case of graphitizing, it is preferable to heat carbon particles, for example, in an inert gas atmosphere such as Ar at a temperature of 2000 to 2500 degrees centigrade, for 3 to 5 hours. The carbon particle to be graphitized may be selected, for example, out of the carbon particles to be employed as the carbon particle 105.

Thereafter, the respective catalytic inks are coated on for example a carbon paper, which is to serve as the gas diffusion layer, and heated and dried so that the fuel electrode 22 and the air electrode 24 are obtained. The coating may be performed for example with a brush or spray. Then the solid polymer electrolyte membrane 20 is interleaved between the fuel electrode 22 and the air electrode 24, such that the respective catalyst layers 26 and 30 confront the solid polymer electrolyte membrane 20, and bonded by hot press method. Thus the cell unit 50 is completed. In case where the solid polymer electrolyte membrane 20 and the ion exchange resin for the catalyst layers 26, 30 are constituted of a polymer that has a softening point or causes a glass transition, it is preferable to execute the hot press at a temperature higher than the softening point or the glass transition temperature.

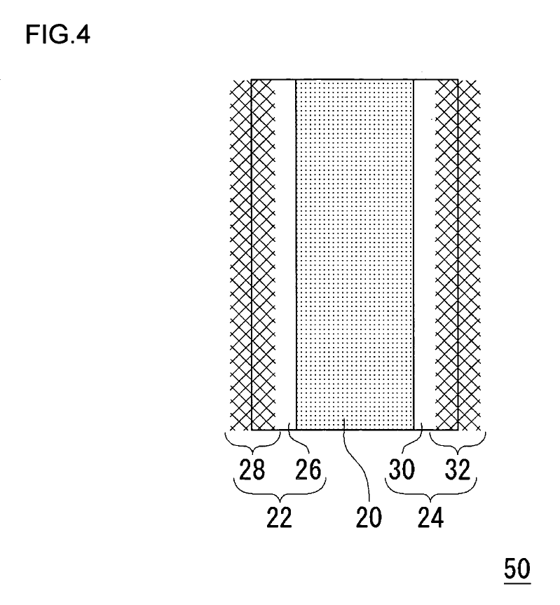

FIG. 4 is a conceptual drawing showing a cross-section of the cell unit 50. As shown therein, in the fuel electrode 22 the catalyst layer 26 is penetrating inside through the surface of the gas diffusion layer 28 made of for example a carbon paper. In the air electrode 24 also, the catalyst layer 30 is penetrating inside the gas diffusion layer 32.

In addition, in the first embodiment the highly graphitized carbon particle 101 is only contained in the catalyst layer 30 of the air electrode 24, but it is also possible to add the highly graphitized carbon particle 101 to the fuel electrode 22. In the latter case, the gas diffusion path is secured in the fuel electrode 22 too, therefore output characteristics of the fuel cell 10 can be further upgraded.

Second Embodiment

This embodiment relates to a fuel cell provided with an air electrode having a catalyst layer containing a highly graphitized carbon particle according to the first embodiment, wherein the gas diffusion layer in the air electrode contains the carbon particle for supporting catalyst and the highly graphitized carbon particle.

FIG. 2 is a conceptual drawing showing the gas diffusion layer 32 in the air electrode 24. As shown therein, a carbon paper 111 is loaded with the highly graphitized carbon particle 101 and the carbon particle 105 for supporting catalyst. Since the highly graphitized carbon particle 101 has a water-repellent surface, water existing in the gas diffusion layer 32 is efficiently discharged outside the air electrode 24 when the highly graphitized carbon particle 101 is loaded on the carbon paper 111. Besides, a gas path is secured in the proximity of the surface of the highly graphitized carbon particle 101. Also, since the carbon particle 105 for supporting catalyst has a hydrophilic surface, appropriate water retention is performed in the gas diffusion layer 32 when the carbon particle 105 is loaded on the carbon paper 111, besides a moisture discharging path is formed. Further, because of the existence of the highly graphitized carbon particle 101 and the carbon particle 105, conductivity of the gas diffusion layer 32 is improved. Accordingly, the gas diffusion layer 32 attains excellent electrode characteristics because of the high moisture discharging efficiency, appropriate water retention and high conductivity.

The fuel cell according to the second embodiment can be manufactured in a similar way to the first embodiment. In addition, for loading the highly graphitized carbon particle 101 and the carbon particle 105 on the carbon paper 111, such method is feasible as dispersing the highly graphitized carbon particle 101 and the carbon particle in a liquid, dipping the carbon paper 111 in the dispersed solution, and drying. After drying, a heat treatment may be applied at, for example, 300 to 500 degrees centigrade. Also, it is preferable that a content of the highly graphitized carbon particle 101 in the gas diffusion layer 32 is in a range of 3 wt. % to 30 wt. %. In this range, the gas path is desirably formed in the gas diffusion layer 32. Further, it is preferable that a content of the carbon particle 105 in the gas diffusion layer 32 is in a range of 1 wt. % to 20 wt. %.

The present invention has been described as above referring to the embodiments. It is to be understood that these embodiments are only exemplifying and that it is apparent to those skilled in the art that various modifications can be made to the respective constituents or processing steps or combinations thereof, without departing from the spirit and scope of the present invention.

What is claimed is:

1. An electrode for a fuel cell comprising:
a gas diffusion layer; and
a catalyst layer formed over said gas diffusion layer;
wherein said catalyst layer comprises a first carbon particle, a catalytic metal supported on said first carbon particle, an ion exchange resin and a second carbon particle; and
a surface of said second carbon particle is water-repellent.

2. The electrode for a fuel cell as set forth in claim 1, wherein an average value of lattice spacing of the [002] plane, d₀₀₂, of said second carbon particle is not less than 0.337 nm but not greater than 0.348 nm.

3. The electrode for a fuel cell as set forth in claim 1, wherein a crystallite size in a direction of c-axis, L_{c}(002), of said second carbon particle is not less than 3 nm but not greater than 18 nm.

4. The electrode for a fuel cell as set forth in claim 2, wherein a crystallite size in a direction of c-axis, L_{c}(002), of said second carbon particle is not less than 3 nm but not greater than 18 nm.

5. The electrode for a fuel cell as set forth in claim 1, wherein said gas diffusion layer also includes said first carbon particle and said second carbon particle.

6. The electrode for a fuel cell as set forth in claim 2, wherein said gas diffusion layer also includes said first carbon particle and said second carbon particle.

7. The electrode for a fuel cell as set forth in claim 3, wherein said gas diffusion layer also includes said first carbon particle and said second carbon particle.

8. The electrode for a fuel cell as set forth in claim 4, wherein said gas diffusion layer also includes said first carbon particle and said second carbon particle.

9. A fuel cell comprising:
an electrode for a fuel cell on fuel supply side;
an electrode for a fuel cell on oxygen supply side; and
a solid polymer electrolyte membrane placed between said electrodes;
wherein at least said electrode for a fuel cell on oxygen supply side is said electrode for a fuel cell as set forth in claim 1.

10. A fuel cell comprising:
an electrode for a fuel cell on fuel supply side;
an electrode for a fuel cell on oxygen supply side; and
a solid polymer electrolyte membrane placed between said electrodes;
wherein at least said electrode for a fuel cell on oxygen supply side is said electrode for a fuel cell as set forth in claim 2.

11. A fuel cell comprising:
an electrode for a fuel cell on fuel supply side;
an electrode for a fuel cell on oxygen supply side; and
a solid polymer electrolyte membrane placed between said electrodes;
wherein at least said electrode for a fuel cell on oxygen supply side is said electrode for a fuel cell as set forth in claim 3.

12. A fuel cell comprising:
an electrode for a fuel cell on fuel supply side;
an electrode for a fuel cell on oxygen supply side; and
a solid polymer electrolyte membrane placed between said electrodes;
wherein at least said electrode for a fuel cell on oxygen supply side is said electrode for a fuel cell as set forth in claim 4.

13. A fuel cell comprising:
an electrode for a fuel cell on fuel supply side;
an electrode for a fuel cell on oxygen supply side; and
a solid polymer electrolyte membrane placed between said electrodes;
wherein at least said electrode for a fuel cell on oxygen supply side is said electrode for a fuel cell as set forth in claim 5.

14. A fuel cell comprising:
an electrode for a fuel cell on fuel supply side;
an electrode for a fuel cell on oxygen supply side; and
a solid polymer electrolyte membrane placed between said electrodes;
wherein at least said electrode for a fuel cell on oxygen supply side is said electrode for a fuel cell as set forth in claim 6.

15. A fuel cell comprising:
an electrode for a fuel cell on fuel supply side;
an electrode for a fuel cell on oxygen supply side; and
a solid polymer electrolyte membrane placed between said electrodes;
wherein at least said electrode for a fuel cell on oxygen supply side is said electrode for a fuel cell as set forth in claim 7.

16. A fuel cell comprising:
an electrode for a fuel cell on fuel supply side;
an electrode for a fuel cell on oxygen supply side; and
a solid polymer electrolyte membrane placed between said electrodes;
wherein at least said electrode for a fuel cell on oxygen supply side is said electrode for a fuel cell as set forth in claim 8.
